(19) United States
(12) Patent Application Publication
(10) Pub. No.: US 2018/0302462 A1
(43) Pub. Date: Oct. 18, 2018

(54) SOCIAL MEDIA SERVER FOR PROVIDING CLIENT WITH MEDIA CONTENT INCLUDING TAGGING INFORMATION AND THE CLIENT

(71) Applicant: KOREA INSTITUTE OF SCIENCE AND TECHNOLOGY, Seoul (KR)

(72) Inventor: Yong-Moo KWON, Seoul (KR)

(21) Appl. No.: 15/674,497

(22) Filed: Aug. 10, 2017

(30) Foreign Application Priority Data
Apr. 12, 2017 (KR) 10-2017-0047081

(51) Int. Cl. H04L 29/08; G06F 17/30

(52) U.S. Cl. CPC H04L 67/06; H04L 67/02; G06F 17/30023; G06F 17/30864; H04L 67/1095

(57) ABSTRACT

Disclosed is a method for providing a media content including tagging information to a client terminal, which includes: by a social media server, when a media content is requested by a client terminal accessing the social media server, providing the requested media content and tagging information (13) of the requested media content to the client terminal.

### CROSS-REFERENCE TO RELATED APPLICATION

This application claims priority to Korean Patent Application No. 10-2017-0047081, filed on Apr. 12, 2017, and all the benefits accruing therefrom under 35 U.S.C. § 119, the contents of which in its entirety are herein incorporated by reference.

### BACKGROUND

### 1. Field

The present disclosure relates to a method of providing tagging information from a social media server to a client terminal and processing the tagging information at the client terminal so that the tagging information may be processed by the client terminal.

### 2. Description of the Related Art

By using a social media, a user may upload media contents such as photo or video, make a comment on an uploaded media content, or tag persons in photos or other social media friends. These commenting or tagging may further increase the interest of others in the media content and add a wealth of information about the media content.

However, to make a comment on a media content or to tag a specific person, a user should be kept in a connected state to the social media. Without connecting to the social media, a user is not able to make an action like commenting on the media content. In addition, a user is not able to save comment or tagging contents related to a media content registered on a social media in the user's device, besides the media content.

In the existing technique, if a user downloads a media content such as an image from a social media, the user may check only the media content and meta information related to the media content.

FIG. 1 shows a scene where a social media is used according to the existing technique and a scene where a local application for an image viewer installed in a user terminal is used. In FIG. 1, a media content thumbnail in the local application is depicted along with an enlarged view of the thumbnail to distinguish a social media scene provided by a social media server from a local application scene of the user terminal.

Referring to FIG. 1, a user may upload a media content at an SNS and post tagging information such as a comment. However, the user is only able to download the media content to the user's device. The downloaded media content may be checked through the local application of the user as shown in FIG. 1, but the tagging information related to the media content cannot be checked at all.

As mentioned above, comment and tagging contents related to media content include additional information about the corresponding media content, and thus the meaning of the media content may be renewed through the comment and tagging contents. However, the comment and tagging contents may be stored only in the social media.

### RELATED LITERATURES

### Patent Literature

(Patent Literature 1) US patent publication US2013/0346068 A1

(Patent Literature 2) US patent publication US2014/0086458 A1

### SUMMARY

To address the above problem, the present disclosure provides a method for allowing a user to store and use a media content, uploaded to a social media, on a local device.

In one aspect, there is provided a social media server for providing a media content including tagging information to a client terminal, the social media server comprising: a media content processing device configured to, when a media content is requested by a client terminal accessing the social media server, provide the requested media content and tagging information 13 of the requested media content to the client terminal.

In an embodiment, the tagging information may include at least one selected from the group consisting of the number of faces; a face identifier having each face location coordinate; social information of each face identifier; a voice message; a voice message creator; the number of comments; a comment content; a comment creator; and social information of the voice message creator or the comment creator, which are included in the media content.

In an embodiment, the social information may include at least one selected from the group consisting of a phone number, an email address and another social media account.

In an embodiment, when the client terminal accesses the social media server after the tagging information 13 of the media content stored in the client terminal is modified by the client terminal to generate changed tagging information 13′, the media content processing device may update the tagging information 13 of the media content on the basis of the changed tagging information 13′.

In an embodiment, the media content processing device may display an updated portion of the updated tagging information, which is updated on the basis of the changed tagging information 13′, after adding time information when the changed tagging information 13′ is generated thereto.

In an embodiment, the social media server may further comprise a storage device in which the media content and the tagging information of the media content are grouped and stored, and when a search request for the media content is received from the client terminal, the media content processing device may provide a search result to the client terminal as a grouped media content unit.

In another aspect of the present disclosure, there is provided a method for providing a media content including tagging information to a client terminal, the method comprising: by a social media server, when a media content is requested by a client terminal accessing the social media server, providing the requested media content and tagging information 13 of the requested media content to the client terminal.

In an embodiment, the tagging information may include at least one selected from the group consisting of the number of faces; a face identifier having each face location coordinate; social information of each face identifier; a voice message; a voice message creator; the number of comments; a comment content; a comment creator; and social information of the voice message creator or the comment creator, which are included in the media content, and the social information may include at least one selected from the group consisting of a phone number, an email address and another social media account.

In an embodiment, the method may further comprise the step of: when the client terminal accesses the social media server after the tagging information 13 of the media content stored in the client terminal is modified by the client terminal to generate changed tagging information 13′ in a state where the client terminal does not access the social media server, updating the tagging information 13 of the media content on the basis of the changed tagging information 13′.

In another aspect of the present disclosure, there is provided a client terminal, comprising: a media content-related information storage device configured to receive a media content and tagging information 13 of the media content from a social media server and store the same; and a media content management device configured to display the stored media content and the stored tagging information 13 on a display, wherein the media content management device modifies the tagging information 13 stored in the media content-related information storage device on the basis of a user input to generate changed tagging information 13′, and transmits the changed tagging information to the social media server.

In an embodiment, the tagging information may include at least one selected from the group consisting of the number of faces; a face identifier having each face location coordinate; social information of each face identifier; a voice message; a voice message creator; the number of comments; a comment content; a comment creator; and social information of the voice message creator or the comment creator, which are included in the media content, and the social information may include at least one selected from the group consisting of a phone number, an email address and another social media account.

In an embodiment, the media content-related information storage device may receive and store the media content and the tagging information 13 in a state where the client terminal accesses the social media server, and the media content management device may generate the changed tagging information 13′ in a state where the client terminal does not access the social media server.

According to an embodiment of the present disclosure, a user may download and store tagging information related to a media content together with the media content from a social media. In addition, a user may modify the tagging information without accessing the social media, and reflect the modified tagging information in the social media by accessing the social media.

Therefore, a user may not only possess the tagging information but also advantageously use the social media while being less restricted to Internet access environment.

### BRIEF DESCRIPTION OF THE DRAWINGS

FIG. 1 shows a scene where a social media is used according to the existing technique and a scene where a local application for an image viewer installed in a user terminal is used.

FIG. 2 shows a computing environment where a social media server 1000 according to an embodiment of the present disclosure is in operation.

FIG. 3 is a block diagram showing a media content file according to an embodiment of the present disclosure.

FIG. 4 shows transmission of a media content file 10 between a social media server 1000 and a client terminal 2000 according to an embodiment of the present disclosure.

FIG. 5 illustrates a process of modifying tagging information 13 at a client terminal 2000 and reflecting the modified information to the social media according to an embodiment of the present disclosure.

FIG. 6 shows an example where a media content is searched based on the media content and its tagging information, and then grouped media contents including the tagging information are displayed.

FIGS. 7 and 8 are diagrams for illustrating a process of treating a media content according to an embodiment of the present disclosure.

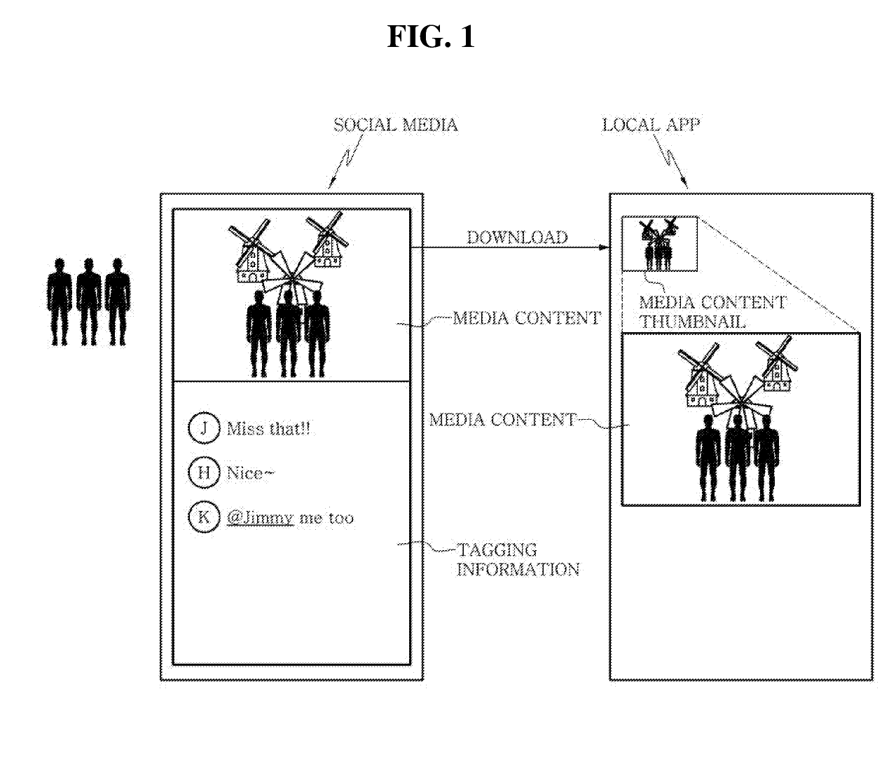

### DETAILED DESCRIPTION

The embodiments described in the specification may be implemented as hardware entirely, hardware partially and software partially, or software entirely. In the specification, the term “unit”, “module”, “device”, “system” or the like indicates a computer-related entity like hardware, a combination of hardware and software, or software. For example, the term “unit”, “module”, “device”, “system” or the like used in the specification may be a process, a processor, an object, an executable file, a thread of execution, a program, and/or a computer, without being limited thereto. For example, both a computer and an application executed in the computer may correspond to the term “unit”, “module”, “device”, “system” or the like in the specification.

The embodiments have been described with reference to the flowchart shown in the figure. For brief explanation, the method has been illustrated and described as a series of blocks, but the present disclosure is not limited to the order of the blocks. In other words, some blocks may be executed simultaneously with other blocks or in a different order from those illustrated and described in this specification, and various diverges, flow paths, block sequences may also be implemented if they give the equivalent or similar results. In addition, in order to implement the method described in the specification, it is also possible not to demand all blocks. Further, the method for predicting a surgery stage may be implemented in the form of a computer program for executing a series of processes, and the computer program may also be recorded on a computer-readable recording medium.

Hereinafter, embodiments of the present disclosure will be described in detail with reference to the drawings.

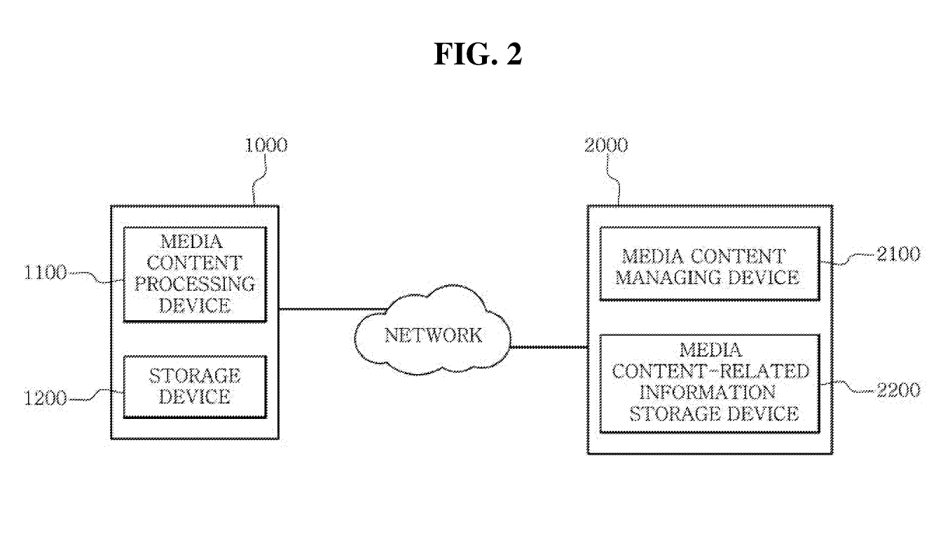

FIG. 2 shows a computing environment where a social media server 1000 according to an embodiment of the present disclosure is in operation. Referring to FIG. 2, the social media server 1000 for providing a media content including tagging information to a client terminal is connected to the client terminal 2000 through a network.

The social media server 1000 may provide a social service such as an on-line community, social network service and a blog service. For example, the social media server 1000 may include FACEBOOK®, CYWORLD®, GOOGLE®, DAUM®, NAVER®. FLICKR®, TWITER®, LINKNOW®, WEEBLY®, TODOLY®, RAINMAKER®, SEESMIC®, SLIDEROCKET®, LINKEDIN®, PINTEREST® or the like.

The client terminal 2000 may be a user device and may include a smart phone, a tablet PC, a notebook, a desktop, and the like. A user may access the social media server 1000 through the client terminal 2000 and use the social network service. For example, the user may upload, share and download media contents.

The media content may include at least one of image, video, music, text, and voice. In this specification, an image is described as an example of the media content, for simple explanation of the present disclosure.

Referring to FIG. 2, the social media server 1000 may include a media content processing device 1100 and may further include a storage device 1200.

If the media content is requested by the client terminal 2000 accessing the social media server 1000, the media content processing device 1100 may provide the requested media content and tagging information 13 of the requested media content to the client terminal 2000.

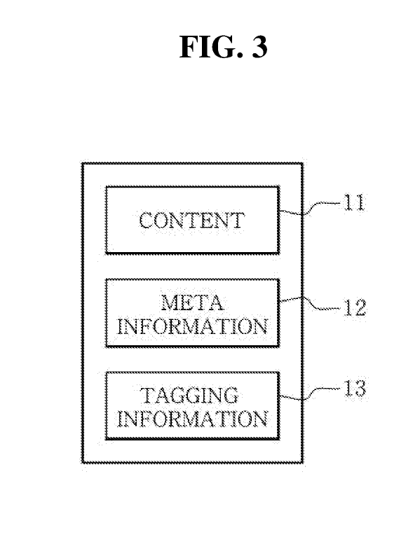

FIG. 3 is a block diagram showing a media content file according to an embodiment of the present disclosure. The media content file 10 may include a content 11, meta information 12 and tagging information 13. The content 11 is a media content, which may include an image or a video.

The meta information 12 is meta information of the media content, which may include mechanical or geographical environment in which the media content is generated. For example, if the media content is a picture, the meta information may be defined in EXIF or DIG35 format.

The tagging information 13 may include at least one selected from the group consisting of the number of faces; a face identifier having each face location coordinate; social information of each face identifier; a voice message; a voice message creator; the number of comments; a comment content; a comment creator; and social information of the voice message creator or the comment creator, which are included in the media content. Here, the social information may include at least one selected from the group consisting of a phone number, an email address and another social media account.

In one example, the tagging information may be configured as shown in Table 1 below.

TABLE 1
the number of faces in a picture

| | | |
|---|---|---|
| face ID | coordinate of a face area | |
| | (center point, radius) | |
| name information | social information (email, | |
| | phone number, messenger account) | |
| voice message ID | voice message file | |
| the number of | comment ID | comment |
| comments | | content |

Referring to FIG. 2 again, if the client terminal 2000 requests transmission of a media content uploaded on the social media server 1000, the media content processing device 1100 may transmit the media content file 10 to the client terminal 2000.

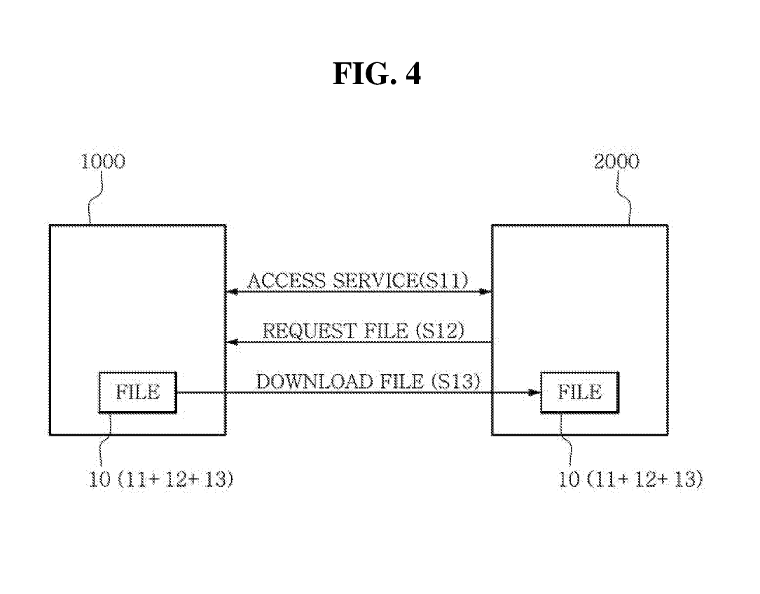

FIG. 4 shows transmission of the media content file 10 between the social media server 1000 and the client terminal 2000 according to an embodiment of the present disclosure. Referring to FIG. 4, the client terminal 2000 accesses the social media server 1000 (S11).

Here, ‘access’ means a state where the client terminal logs in the social media server or is connected to a web page or the like without log-in.

The client terminal 2000 requests the media content file 10 (S12). When requesting the media content file 10, the social media server 1000 may guide the provided information to be distinguished into various levels as shown in Table 2 below. Table 2 shows the case where the media content is an image, and the meta information 12 is not displayed. The meta information 12 may be included in at least one of the two options.

TABLE 2

download the image 11
download the image 11 and the tagging information 13

In the example of FIG. 4, the user selects “download the image 11 and the tagging information 13 as an example. In response to the file request (S12), the media content processing device 1100 provides the media content file 10 to the client terminal 2000 (S13). In other words, the media content file 10 is downloaded from the social media server 1000 to the client terminal 2000. The downloaded media content file 10 may be stored in the storage device of the client terminal 2000 and executed by means of a local application of the client terminal 2000.

The local application may give a user interface identical to or similar to the social media. Thus, the user may input tagging information (comment, person tagging, or the like) about the media content downloaded to the client terminal, in a similar way of using a social media.

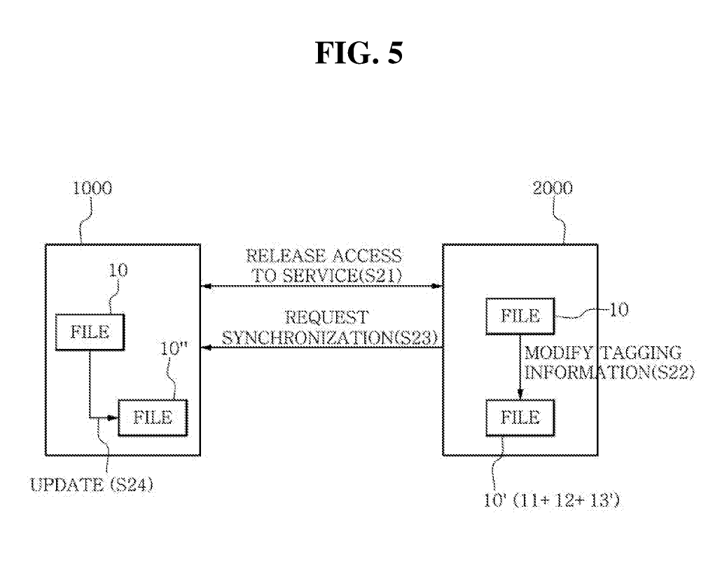

FIG. 5 illustrates a process of modifying the tagging information 13 at the client terminal 2000 and reflecting the modified information to the social media according to an embodiment of the present disclosure.

Referring to FIG. 5, the client terminal may be in a state of being disconnected from the social media server. Thus, the media content 10 stored in the client terminal 2000 may be modified by a local application installed at the client terminal 2000 or a web service provided by a server other than the social media server.

Referring to FIG. 5, the tagging information 13 of the media content 10 stored in the client terminal 2000 may be modified by the client terminal 2000 to generate changed tagging information 13′. The changed tagging information 13′ may be generated by partially changing the tagging information 13, when a comment is added or a person tagging is added. More specifically, the tagging information 13 is updated into or replaced with the changed tagging information 13′. Accordingly, the media content file 10 stored in the client terminal 2000 is also updated. In FIG. 5, the updated media content file is designated with a reference sign 10′.

After that, if the client terminal 2000 accesses the social media server 1000 and requests synchronization of the media content file 10 (S23), the media content processing device 1100 may update the tagging information 13 of the media content file 10 stored in the storage device 1200 of the media server 1000 on the basis of the changed tagging information 13′ in the media content file 10′ to generate an updated media content file 10″ (S24). The media content file 10″ may be identical to or different from the media content file 10′.

For example, after the client terminal 2000 downloads the media content file 10, if the media content 10 stored in the social media server 10 is updated (for example, a new comment is written) before requesting synchronization of the media content file 10′ (a first period), the media content processing device 1100 reflects both the modifications made during the first period and the modifications made by the client terminal 2000. Thus, the media content files 10″ and 10′ may be different from each other.

In an embodiment, the media content processing device 1100 may display the updated portion on the basis of the changed tagging information 13′ in the updated tagging information by adding the time information when the changed tagging information 13′ is generated. For example, it is possible to display not only the input time of a comment entered on the client terminal and the time synchronized with the social media, without accessing the social media. Thus, a third party may check an actual input time of the added comment (the time when the comment is entered on the client terminal).

In an embodiment, the storage device 1200 may store the media content and the tagging information of the media content in a grouped state. In addition, if a search request for the media content is received from the client terminal 2000, the media content processing device 1100 may provide a search result to the client terminal 2000 as a grouped media content unit.

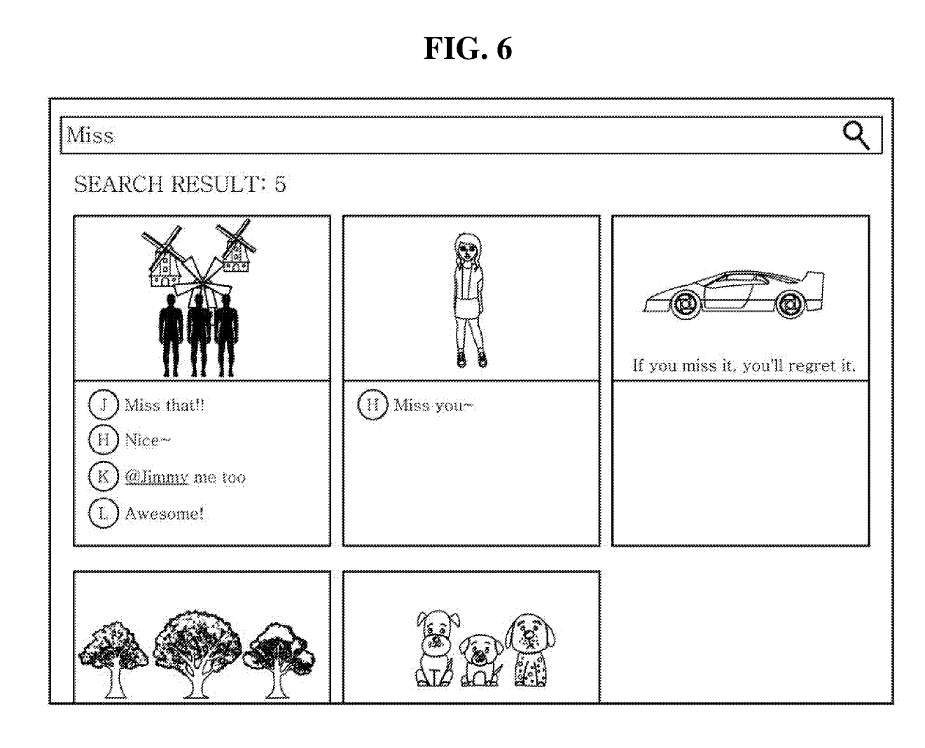

FIG. 6 shows an example where a media content is searched based on the media content and its tagging information, and then grouped media contents including the tagging information are displayed. The example of FIG. 6 may be implemented by the social media server or the client terminal.

The method for providing a media content including tagging information to a client terminal according to an embodiment of the present disclosure may include the step of, by a social media server, when a media content is requested by a client terminal accessing the social media server, providing the requested media content and tagging information 13 of the requested media content to the client terminal. The above step may be performed by the social media server described above.

In addition, the above method may further include the step of, when the client terminal accesses the social media server after the tagging information 13 of the media content stored in the client terminal is modified by the client terminal to generate changed tagging information 13′ in a state where the client terminal does not access the social media server, updating the tagging information 13 of the media content on the basis of the changed tagging information 13′.

Referring to FIG. 2 again, the client terminal 2000 according to an embodiment of the present disclosure may include a media content-related information storage device 2200 for receiving and storing a media content and tagging information 13 of the media content from the social media server, and a media content management device 2100 for displaying the stored media content and the stored tagging information 13 on a display.

In one embodiment, the media content-related information storage device 2200 may receive and store the media content and the tagging information 13 in a state where the client terminal accesses the social media server. The media content management device 2100 may generate the changed tagging information 13′ in a state where the client terminal does not access the social media server.

In addition, the media content-related information storage device 2200 may store the media content and the tagging information of the media content in a grouped state. If a search request for the media content is received from a user, the client terminal 2000 may provide a search result as a grouped media content unit.

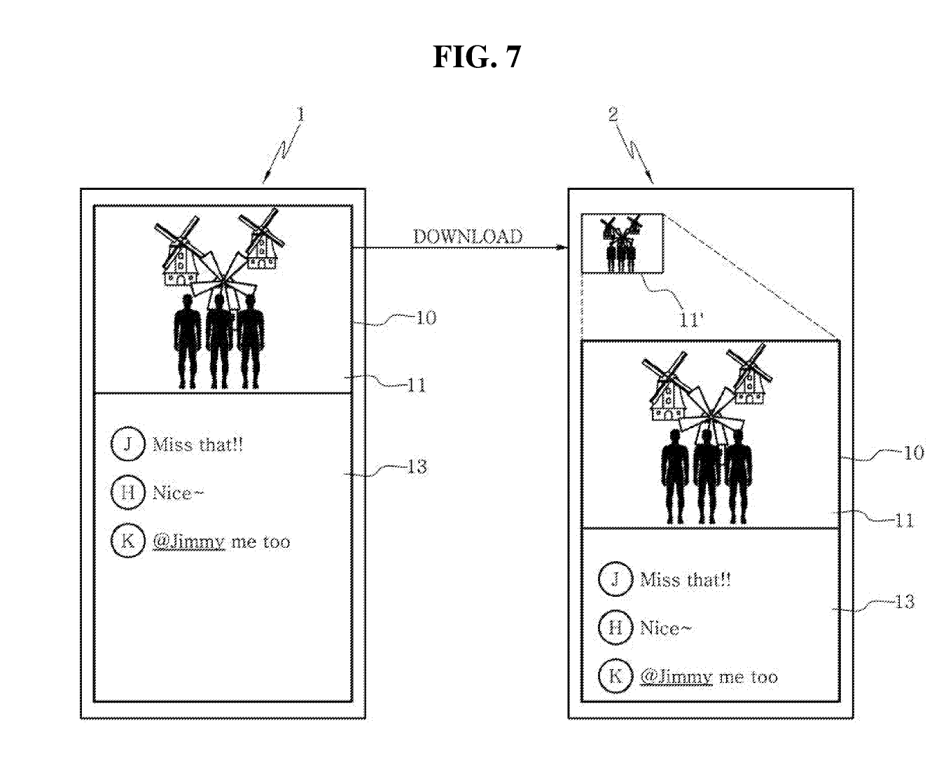

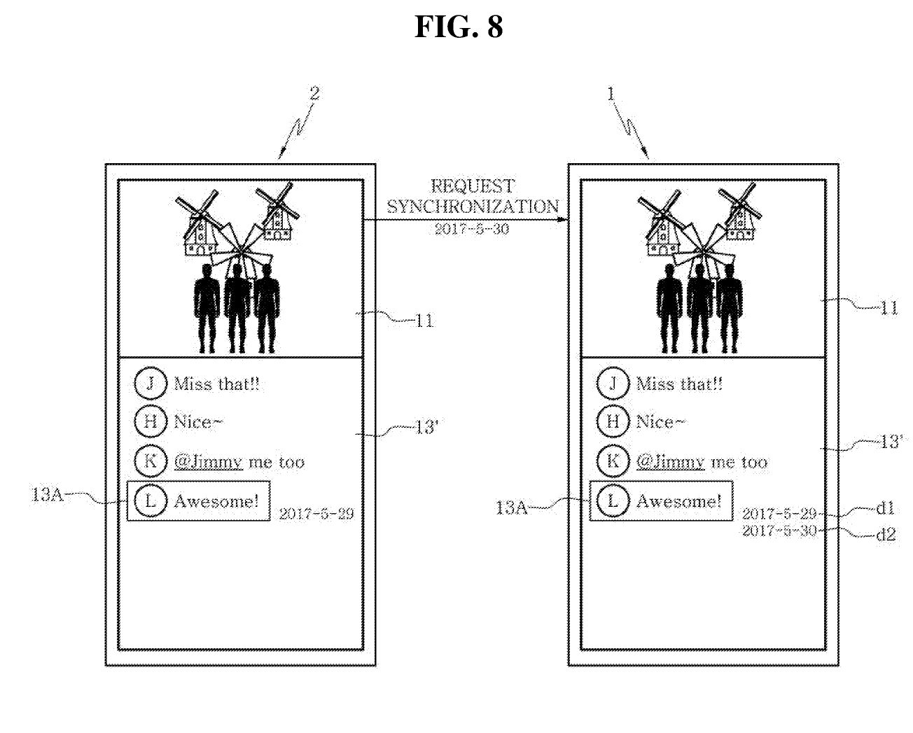

FIGS. 7 and 8 are diagrams for illustrating a process of treating a media content according to an embodiment of the present disclosure. In FIGS. 7 and 8, a reference sign 1 shows a scene where a web page or an application page is executed by the social media server, and a reference sign 2 shows a scene where a local application (for example, a video playing application) installed at the client terminal is executed. Both the scenes 1 and 2 are displayed on the display of the client terminal, but it should be noted that they are executed by the social media server and the client terminal, differently.

Referring to FIG. 7, the client terminal may download the media content file 10 from the social media server and check the media content by means of the local application. When the media content is downloaded, the tagging information 13 of the media content is also downloaded. Thus, the media content 11 and the tagging information 13 may be executed at the client terminal. In other words, the user may check the image 11 and three comments 13 by means of the client terminal.

Referring to FIG. 8, the user may input a new comment 13A by means of the client terminal. Accordingly, the tagging information 13 may be modified. If the client terminal accesses the social media, the client terminal may request synchronization so that the modified tagging information 13′ is also applied to the media content 11 on the social media. The request for synchronization may include providing the social media server with the modified tagging information 13′ or the information of the media content file 10 including the modified tagging information 13′. In the example of FIG. 8, it is assumed that the date on which the new comment 13A is input is May 29, and the date of requesting synchronization is May 30.

According to the request for synchronization, the social media server compares the tagging information of the media content 11 provided from the client terminal with the tagging information of the media content 11 stored in the social media server, and updates the tagging information 13 stored in the social media server into the tagging information 13. Accordingly, the comment 13A entered by the user on May 29 may be registered in the social media server. In this case, the actual entry date d1 of the new comment and the synchronized date d2 may be displayed on the social media.

Even though the present disclosure has been explained with reference to the embodiments depicted in the figures, they are just examples, and it will be understood by those skilled in the art that various changes and modifications may be made therefrom. However, such changes or modifications should be regarded as falling within the scope of the present disclosure. Therefore, the true scope of the present disclosure must be defined by the appended claims.

What is claimed is:

1. A social media server for providing a media content including tagging information to a client terminal, the social media server comprising:
a media content processing device configured to, when a media content is requested by a client terminal accessing the social media server, provide the requested media content and tagging information (13) of the requested media content to the client terminal.

2. The social media server for providing a media content including tagging information to a client terminal according to claim 1,
wherein the tagging information includes at least one selected from the group consisting of the number of faces; a face identifier having each face location coordinate; social information of each face identifier; a voice message; a voice message creator; the number of comments; a comment content; a comment creator; and social information of the voice message creator or the comment creator, which are included in the media content.

3. The social media server for providing a media content including tagging information to a client terminal according to claim 2,
wherein the social information includes at least one selected from the group consisting of a phone number, an email address and another social media account.

4. The social media server for providing a media content including tagging information to a client terminal according to claim 1,
wherein when the client terminal accesses the social media server after the tagging information (13) of the media content stored in the client terminal is modified by the client terminal to generate changed tagging information (13′), the media content processing device updates the tagging information (13) of the media content on the basis of the changed tagging information (13′).

5. The social media server for providing a media content including tagging information to a client terminal according to claim 4,
wherein the media content processing device displays an updated portion of the updated tagging information, which is updated on the basis of the changed tagging information (13′), after adding time information when the changed tagging information (13′) is generated thereto.

6. The social media server for providing a media content including tagging information to a client terminal according to claim 1, further comprising:
a storage device in which the media content and the tagging information of the media content are grouped and stored,
wherein when a search request for the media content is received from the client terminal, the media content processing device provides a search result to the client terminal as a grouped media content unit.

7. A method for providing a media content including tagging information to a client terminal, the method comprising:
by a social media server, when a media content is requested by a client terminal accessing the social media server, providing the requested media content and tagging information (13) of the requested media content to the client terminal.

8. The method for providing a media content including tagging information to a client terminal according to claim 7,
wherein the tagging information includes at least one selected from the group consisting of the number of faces; a face identifier having each face location coordinate; social information of each face identifier; a voice message; a voice message creator; the number of comments; a comment content; a comment creator; and social information of the voice message creator or the comment creator, which are included in the media content, and
wherein the social information includes at least one selected from the group consisting of a phone number, an email address and another social media account.

9. The method for providing a media content including tagging information to a client terminal according to claim 8, further comprising the step of:
when the client terminal accesses the social media server after the tagging information (13) of the media content stored in the client terminal is modified by the client terminal to generate changed tagging information (13′) in a state where the client terminal does not access the social media server, updating the tagging information (13) of the media content on the basis of the changed tagging information (13′).

10. A client terminal, comprising:
a media content-related information storage device configured to receive a media content and tagging information (13) of the media content from a social media server and store the same; and
a media content management device configured to display the stored media content and the stored tagging information (13) on a display,
wherein the media content management device modifies the tagging information (13) stored in the media content-related information storage device on the basis of a user input to generate changed tagging information (13′), and transmits the changed tagging information to the social media server.

11. The client terminal according to claim 10,
wherein the tagging information includes at least one selected from the group consisting of the number of faces; a face identifier having each face location coordinate; social information of each face identifier; a voice message; a voice message creator; the number of comments; a comment content; a comment creator; and social information of the voice message creator or the comment creator, which are included in the media content, and
wherein the social information includes at least one selected from the group consisting of a phone number, an email address and another social media account.

12. The client terminal according to claim 11,
wherein the media content-related information storage device receives and stores the media content and the tagging information (13) in a state where the client terminal accesses the social media server, and
wherein the media content management device generates the changed tagging information (13′) in a state where the client terminal does not access the social media server.
